(19) United States
(12) Patent Application Publication
(10) Pub. No.: US 2026/0331657 A1
(43) Pub. Date: Oct. 22, 2026

(54) LID CLOSURE FOR A SECONDARY CELL

(71) Applicant: Northvolt AB, Stockholm (SE)

(72) Inventor: Michael SHAUGHNESSY, Västerås (SE)

(21) Appl. No.: 19/491,550

(22) PCT Filed: Jun. 12, 2024
(86) PCT No.: PCT/EP2024/066228

§ 371 Date: Dec. 9, 2025

(30) Foreign Application Priority Data
Jun. 20, 2023 (SE) 2350758-5

(51) Int. Cl. H01M 50/152; H01M 10/04; H01M 50/107; H01M 50/148; H01M 50/169; H01M 50/213; H01M 50/249

(52) U.S. Cl. CPC H01M 50/152; H01M 10/0422; H01M 50/107; H01M 50/154; H01M 50/169; H01M 50/213; H01M 50/249

(57) ABSTRACT

There is disclosed herein a cylindrical secondary cell and a method of manufacturing thereof. The cell comprises a cylindrical casing (102) extending along an axis (A) from a first end (102a) to a second end (102b), the first end (102a) being an open end of the casing (102), an electrode roll (104) housed within the casing (102), and a lid (106) closing the open end (102a) of the casing (102). Advantageously, the edge of the open end (102a) is bent inwards to provide a flange (102d) comprising an angled surface (102e) sloping towards the second end (102b) of the casing (102), and the lid (106) is configured to be attached to the flange (102d).

### TECHNICAL FIELD

The present disclosure relates to a cylindrical secondary cell, and a method of manufacturing such a secondary cell, wherein the secondary cell has a casing with an open end and comprises a lid for closing said open end.

### BACKGROUND

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### SUMMARY

The present disclosure aims to provide improved secondary cells and parts thereof. The improvements may be in energy performance, manufacturing efficiency, and assembly simplification, among others.

In particular, according to an aspect of the present disclosure, there is provided a cylindrical secondary cell comprising a cylindrical casing extending along an axis from a first end to a second end, the first end being an open end of the casing, an electrode roll housed within the casing, and a lid closing the open end of the casing. The edge of the open end is bent inwards to provide a flange comprising an angled surface sloping towards the second end of the casing and the lid is configured to be attached to the flange, i.e., by welding, to thereby close the open end of the casing.

The angled surface sloping towards the second end of the casing is formed by bending the edge of the casing inwards, such that the angled surface slopes into an internal volume of the secondary cell, i.e., forming an acute angle between the angled surface and the side wall of the casing. The flange at the edge of the open end may comprise further surfaces, e.g., straight or curved surfaces, in addition to the angled surface, which may also be formed by bending the edge of the open end of the casing.

The lid is configured to be attached to the flange by, e.g., being appropriately dimensioned to abut and, for example, slide along the angled surface, which can thus act as a guiding and centering means for placing the lid against the flange and against the electrode roll, for attaching thereto.

The angled surface advantageously allows for a less strict tolerance to be enforced in the axial/longitudinal direction of the cylindrical cell, in particular with respect to the height of the electrode roll. Indeed, the angled surface may provide advantageous elasticity and/or tolerance in the angle formed relative to the side wall of the casing such that minor variations in the height of the electrode roll can be readily compensated for by, e.g., flexibility of the flange contributed by the angled surface during manufacture of the secondary cell.

In an example, the lid is configured to be attached to the flange in that the periphery of the lid has an angled surface configured to substantially match the angled surface of the flange. For example, if the angled surface of the flange is angled into the casing at an angle of 45 degrees, then the angled surface of the periphery of the lid can be angled away from the internal of the casing at an angle of 45 degrees such that the abutment of these matching angled surfaces forms an area that is well suited to receive, e.g., welding.

In a preferred example, the angled surface of the lid may extend further than the angled surface of the flange of the casing, such that the lid can be biased further into the casing than the flange and thus a secure attachment of the lid to the electrode roll can be ensured.

It will be appreciated that, the greater surface overlapping surface area between the lid and the flange that is provided, the greater area available for attaching the two together will be provided. The lid and the flange may be welded together, e.g., using laser welding, soldering, capacitor discharge welding, or the like. The lid and the flange may be made from different metals, such as aluminum and steel, respectively, or copper and aluminum, etc., or the lid and flange may be made from the same material. Those skilled in the art can readily identify the most appropriate welding means for providing an attachment between the lid and the flange that is mechanically strong and preferably water-tight, and that provides a good electrical connection.

The lid and flange may be arranged against each other in either order, depending on the implementation. That is, the periphery of the lid may be arranged between the flange and the electrode roll, or the flange may be arranged between the periphery of the lid and the electrode roll. It will be appreciated that both arrangements can provide certain benefits, and the configurations and/or construction of the secondary cell may be appropriately adapted for either case.

For example, if the periphery of the lid is arranged between the flange and the electrode roll, then the electrode roll may be advantageously protected from the possibly sharp edge of the open end of the casing that is bent inwards. Alternatively, if the flange is arranged between the periphery of the lid and the electrode roll, then the electrode roll can be conveniently retained in the casing by the flange before and during the arrangement of the lid thereagainst.

The lid may be further configured for enhanced electrical connection with the electrode roll. For example, in a preferred example, the lid comprises a number of recessed contact portions arranged in direct electrical contact with the electrode roll, the area of the recessed contact portions being 50 to 80 percent of the total area of the lid.

In a refinement of such an example, the extension of the recessed contact portions in an axial direction of the cylindrical secondary cell substantially equals the extension of the flange in the axial direction of the cylindrical secondary cell.

Thus, the profile formed by arrangement of the flange of the casing and the periphery of the lid may form a part of a wider profile of the lid that has some axial extension. Accordingly, the electrical connection between the lid and the electrode roll is enhanced while utilizing the volume of the cell in an efficient manner.

The flange is preferably attached to a periphery of the lid along an attachment seam, wherein the attachment seam is axially spaced from the electrode roll. Thus, the means of attachment can be chosen more freely as damage to the electrode roll is made less likely. For example, if the lid and flange are welded together, then the axial spacing from the electrode roll can advantageously prevent the welding heat from damaging the electrode roll.

According to a further aspect of the present disclosure, welding is the preferred means of attachment for the lid and the flange. That is, according to a further aspect of the present disclosure, there is provided a method of manufacturing a secondary cylindrical cell substantially as described above, comprising bending the edge of the open end of the casing inwards to thereby form the flange, arranging the periphery of the lid in abutment with the flange, and welding the periphery of the lid and the flange together.

The lid is preferably substantially disc shaped, and preferably comprises a first side for arranging in direct electrical contact with the electrode roll, and a second side opposite the first side.

In the case where the lid is arranged between the flange and the electrode roll, the method comprises arranging the first side of the lid in direct electrical contact with the electrode roll and bending the edge of the open end of the casing inwards to thereby form the flange and bring the flange into contact with the periphery of the second side of the lid.

In the case wherein the flange is arranged between the lid and the electrode roll, the method comprises bending the edge of the open end of the casing inwards to thereby form the flange and arranging the first side of the lid in direct electrical contact with the electrode roll such that the periphery of the first side of the lid contacts the flange.

As discussed above, the angled surface of the flange may allow for less strict tolerances to be implemented, thereby simplifying a mass manufacture of secondary cells. This is because the angled surface can compensate for minor differences in the height (i.e., axial position) of the electrode roll by a simple varying of its angle and/or an ability to compress against the flange in such a way as to ensure an effective contact between the lid and the electrode roll.

Thus, welding the periphery of the lid and the flange together may comprise sensing a contact force between the periphery of the lid and the flange, and welding the periphery of the lid and the flange together in response to the contact force exceeding a threshold force.

In such a way, it can be reliably ensured that the lid and flange are only welded together when they are at such a relative position as to provide a good electrical contact therebetween and/or to provide a good electrical contact between the lid and the electrode roll. Such an approach may be particularly suited to capacitor discharge welding.

Welding the periphery of the lid and the flange together may additionally or alternatively comprise directing a welding means such as a welding laser at the angled surface of the flange from an angle substantially orthogonal to the angled surface of the flange.

Hence, a more convenient welding may be provided, which can better utilize a rotational movement of the cell relative to the welding means, during assembly. Moreover, damage to the electrode roll may be further mitigated by ensuring that the direction of the welding means (e.g., directional laser) is away from the electrode roll.

According to further aspects of the present disclosure, there is provided a battery pack and a vehicle comprising the battery pack. The battery pack comprises a plurality of cylindrical secondary cells, wherein at least one of the plurality of cylindrical secondary cells is a cylindrical secondary cell substantially as described above.

Accordingly, aspects of the present disclosure provide improvements in energy performance, manufacturing efficiency, and assembly simplification, particularly for the closing of the casings of cylindrical secondary cells, among other advantages which will be made clear through the below description of specific embodiments.

### BRIEF DESCRIPTION OF THE DRAWINGS

One or more embodiments of the present disclosure will be described, by way of example only, and with reference to the following figures, in which:

FIG. 1 schematically shows a cross-sectional view of a cylindrical secondary cell, according to an example implementation of the present disclosure;

FIGS. 2A to 2D show enlarged cross-sectional views of an area of a cylindrical secondary cell according to various example implementations of the present disclosure, showing in particular various configurations of a flange of the casing and a lid;

FIGS. 3 and 4 show example processes for manufacturing a cylindrical secondary cell according to aspects of the present disclosure;

FIG. 5 illustrates a generalized method of manufacturing a cylindrical secondary cell, according to aspects of the present disclosure;

FIG. 6 shows a battery pack according to an aspect of the present disclosure; and

FIG. 7 shows a vehicle according to an aspect of the present disclosure.

### DETAILED DESCRIPTION

The present disclosure is described in the following by way of a number of illustrative examples. It will be appreciated that these examples are provided for illustration and explanation only and are not intended to be limiting on the scope of the present disclosure. Instead, the scope of the present disclosure is defined by the appended claims.

Furthermore, although embodiments be presented individually for the sake of focused discussion of particular features, it will be recognized that the present disclosure also encompasses combinations of the embodiments described herein.

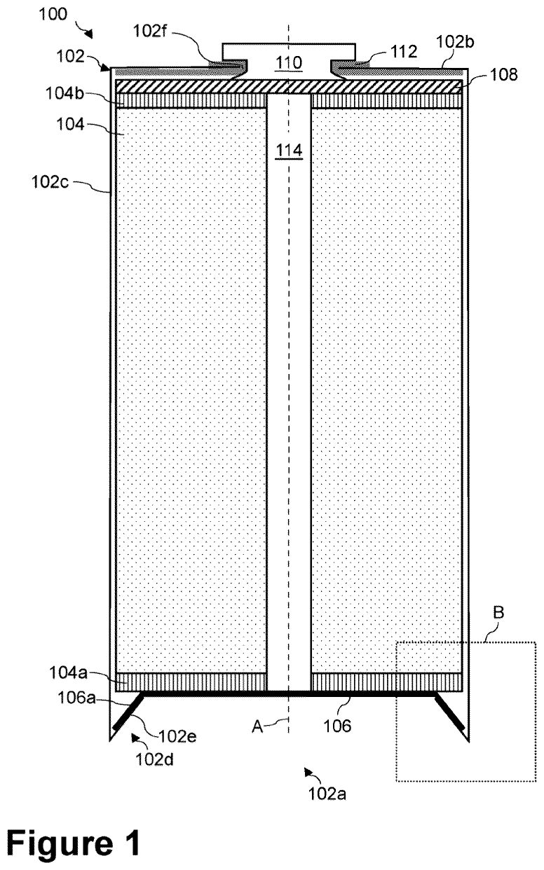

FIG. 1 schematically shows a cross-sectional view of a cylindrical secondary cell 100 (also referred to herein as ‘secondary cell 100’ or simply ‘cell 100’), according to an example implementation of the present disclosure.

The cylindrical secondary cell 100 comprises an electrode roll 104 housed in a cylindrical casing 102. The electrode roll 104 may be formed of an anode sheet, a cathode sheet, and a separator sheet arranged therebetween to thereby enable a storage of electrical energy. Cathode tabs 104b extend from a first end of the electrode roll 104 and anode tabs 104a extend from the other end, although it will be appreciated that the cathode and anode polarities could be reversed in other examples. The cathode tabs provide a connective surface to which current collecting plate 108 can be connected.

The cathode current collecting plate 108 is arranged in direct electrical contact with the cathode tabs 104b. Thus, an electrical connection is formed from the cathode tabs 104b to a rivet 110, as the rivet 110 extends through an opening 102f in the top end 102b of the casing 102 and is connected to the current collecting plate 108. Thus, it is seen that the exposed head of the terminal rivet 110 serves as an external terminal of the cell 100, this being a positive terminal in this example.

The cylindrical casing 102 extends along an axis A between a first end 102b, which may be referred to as a ‘top end 102b’, and an open bottom end 102a which is closed by a lid 106. The casing 102 further comprises a side wall 102c. The electrode roll 104 is arranged around a center pin 114, although in other examples, this may be an empty space or cavity. The center pin 114, electrode roll 104, and side wall 102c of the casing 102 are substantially cylindrical and concentric.

As shown in the figure, the edge of the open end 102e is bent inwards to thereby form a flange 102d. The flange 102d comprises an angled surface 102e. The angled surface 102e of the flange 102d abuts a matching angled surface 106a of the lid 106, arranged at the periphery thereof. These angled surfaces 102e and 106a are welded together (not shown) to form a water-tight or fluid-tight seal such that a liquid electrolyte (not shown) can be contained in the cell 100.

The anode tabs 104a are connected directly to the lid 106 at a more central region thereof, i.e., away from the periphery. Therefore, the casing 102 serves as the negative terminal, and it is advantageously not required to add a further current collecting disc.

Hence, it is seen that both terminals of the cell 100 are accessible at the same side. That is, the top end 102b of the casing 102 comprises a first electrical contact surface extending in a first plane, and the head of the rivet 110 comprises a second electrical contact surface, extending in a second plane axially spaced from the first plane. When a plurality of such cells 100 are arranged in an assembly, busbars or similar such connectors can be arranged along the tops of the cells 100 to interconnect the plurality of cells 100 in a simple manner.

Arranged around the terminal rivet 110 is a gasket 112 configured to form a fluid-tight seal for the opening 102f in the top end 102b of the casing 102. The gasket 112 is arranged at least around the shaft of the rivet 110.

The gasket 112 further extends between the head of the rivet 110 and the top end 102b of the casing 102 so as to electrically isolate the opposite terminals of the cell 100 from each other.

Thus, it can be seen that gasket 110 serves multiple purposes. The gasket 112 may be preferably formed of a polymer having elastic, resilient, and electrically insulating properties, such as PFA. In preferred examples, including that illustrated in FIG. 1, the gasket 112 extends between the head of the rivet 110 and the casing 102, radially beyond the head of the rivet 102.

In some examples, the gasket 112 may be formed of separate parts, each part being specifically configured for a respective purpose. For example, for the part(s) of the gasket 112 around the opening 102f and intended to seal the opening 102f, the gasket 112 may be formed of one material such as PFA. For the part(s) of the gasket 112 between the head of the rivet 110 and the casing 102 and intended to electrically isolate these components from each other, the gasket 112 may be formed from another material such as a PPS polymer.

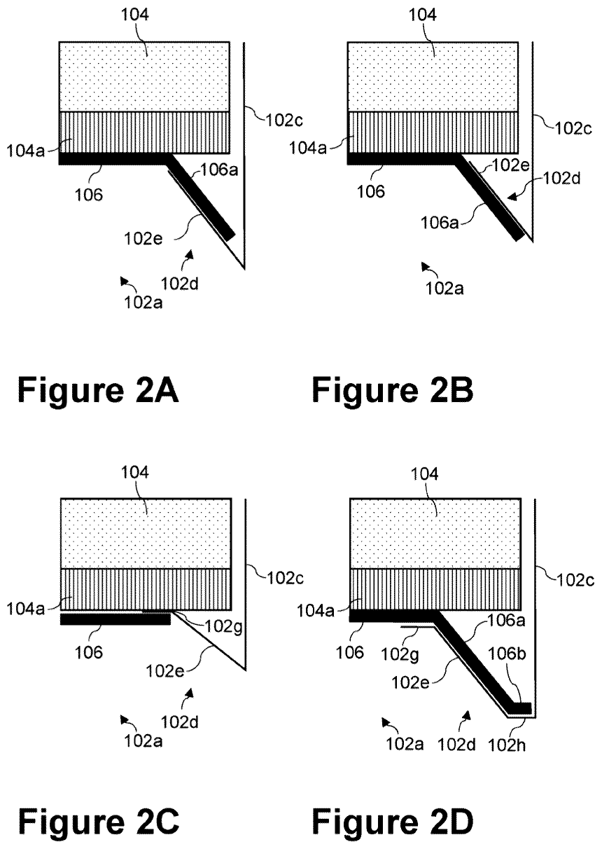

A region B is shown in FIG. 1, at the bottom corner thereof. FIGS. 2A to 2D are each views corresponding to this region B, having various example configurations of a flange 102d and a lid 106.

FIG. 2A shows an example configuration wherein the periphery of the lid 106 is arranged between the flange 102d and the electrode assembly 104, and comprises an angled surface 106a that matches and abuts the angled surface 102e of the flange 102d.

FIG. 2B shows an example configuration wherein the flange 102d is arranged between the periphery of the lid 106 and the electrode assembly 104. As with the configuration shown in FIG. 2A, the periphery of the lid 106 and the flange 102d comprise respective angled surfaces 106a, 102e which match and abut each other to provide an attachment surface for, e.g., receiving a welding means such as a welding laser.

FIG. 2C shows an example configuration wherein the flange 102d comprises an angled surface 102e and a further surface 102g, wherein the further surface 102g is flat against the tabs 104a of the electrode roll 104. The further surface 102g thus provides an abutment surface for the lid 106, which in this example does not have an angle surface at its periphery. The further surface 102g of the flange 102d is arranged between the lid 106 and the electrode assembly 104.

It will be appreciated that, according to such an example configuration, an appropriately dimensioned lid may be advantageously centered along the axis of the cylindrical cell through, e.g., a sliding engagement with the angled surface 102e of the flange 102d that guides the lid 106 into abutment with the further surface 102g. Thereafter, the lid 106 can be welded or otherwise attached to the further surface 102g of the flange 102d, preferably using means that do not transfer excessive heat through the lid 106 and the further surface 102g to thereby risk damaging the electrode assembly 104.

FIG. 2D shows an example configuration wherein the flange 102d and the lid 106 each have angled surfaces 102e, 106a that match and abut each other, where the flange 102d has a further surface 102g that is flat against the electrode tabs 104a, similarly as in FIG. 2C, and a flat apex surface 102h at the apex of the flange 102d. The periphery of the lid 106, being arranged between the flange 102d and the electrode assembly 104, comprises a radially outermost surface 102h that is flat, being configured to match and abut the apex surface 102h of the flange 102d.

Accordingly, the abutment of the surfaces 106a, 106b of the lid 106 with the matching surfaces 102e, 102g, 102h of the flange 102d forms a mechanical engagement that advantageously resists radial displacement and provides a plurality of surfaces via which the lid 106 and flange 102d can be attached.

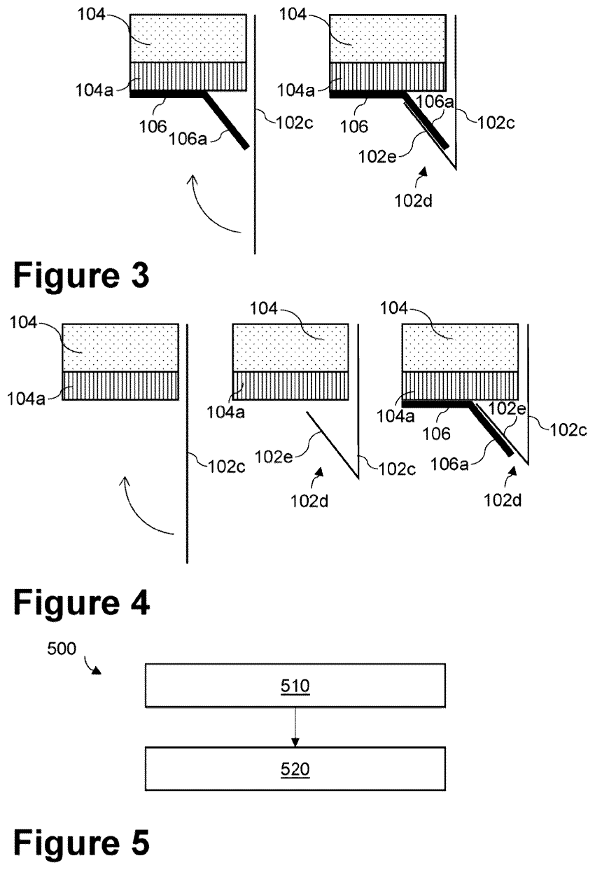

FIG. 3 schematically shows an outline of a process for forming a secondary cell having the example configuration shown in FIG. 2A. According to the illustrated process, the lid 106, already having been welded to the electrode tabs 104a of the electrode assembly 104 comprises an angled surface 106a that substantially radially extends to the side wall 102c of the casing.

The edge of the side wall 102c, initially extending beyond the axial height of the angled surface 106a by an amount that is preferably greater than the length of extension of the angled surface 106a, is bent over to thereby abut the angled surface 106a at the periphery of the lid 106.

The bending may be performed by any suitably means and may be performed according to a predetermined angle (which preferably corresponds to the angle of the angled surface 106a of the lid 106) or may be performed until such a time as sufficient resistance against the bending is sensed, which may indicate that the formed flange 102d is abutting the angled surface 106a of the lid 106.

After the bending, a welding means such as a welding laser is directed at the overlap of the lid 106 and the flange 102d so as to close the open end of the casing in a preferably water-tight fashion.

FIG. 4 schematically shows an outline of a process for forming a secondary cell having the example configuration shown in FIG. 2B. According to the illustrated process, the edge of the side wall 102c is first bent to form the flange 102d, having an angled surface 102e corresponding to the extent of the bending. Thereafter, the lid 106 is introduced and arranged against the electrode tabs 104a of the electrode assembly 104 such that the angled surface 106a of the lid 106 abuts the angled surface 102e of the flange 102d.

After the bending, a welding means such as a welding laser is directed at the overlap of the flange 102d and the lid 106 so as to close the open end of the casing in a preferably water-tight fashion. In an example, the welding of the lid 106 to the electrode tabs 104a may be performed simultaneously with the welding of the periphery of the lid 106 to the flange 102d, so as to accelerate the process.

In the same or different examples, the welding may be performed in response to a sensing of a threshold contact force between the lid 106 and the flange 102d (or between the lid and the electrode tabs 104a) such that it can be readily ensured that the angled surfaces 106a, 102e of the lid 106 and flange 102d are reliably abutting. In such a way, a more reliable seal to close the casing may be formed.

FIG. 5 illustrates a general method 500 of manufacturing a secondary cylindrical cell such as any of those described above, comprising a first step 510 of arranging the periphery of the lid in abutment with the flange, and a second step 520 of welding the periphery of the lid and the flange together.

It will be appreciated that the method 500 may be enhanced or refined in numerous ways, some of which are described above, which may depend on the particular configuration of the secondary cell. Those skilled in the art are aware of means for automating such manufacturing processes, and it will be appreciated that, according to configurations of the lid and casing, in line with aspects of the present disclosure, such manufacturing processes may be advantageously accelerated without an associated risk of poor connection or closures, as greater tolerances can be allowed for in, e.g., axial height of the electrode assembly, among other benefits.

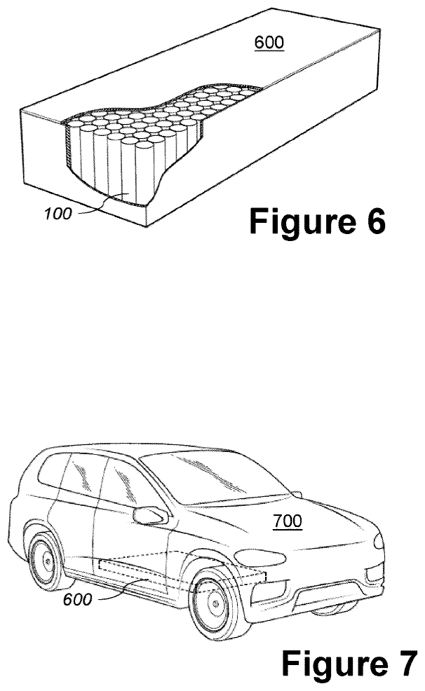

FIG. 6 shows a perspective view of a battery pack 600 with a portion of its casing (being illustrated in a purely schematic way) cut away to schematically show a plurality of secondary cells 100 housed therein. The secondary cells 100 may correspond to the secondary cell 1000 described above and may comprise a lid closure substantially as described above.

The secondary cells 100 are connected together in series and/or parallel, and in an optionally modular fashion, so as to form a combined electrical storage capacity. In some examples, the cells have a common orientation such that failure vents of the cells are oriented in a same direction, and such that the terminals of the cells (which may be on the same side, as discussed in relation to FIG. 1) can be accessed at a same side.

FIG. 7 schematically shows an example vehicle 700 comprising the battery pack 600 shown in FIG. 6. In this example, the battery pack is arranged at a lower portion of the vehicle 700, which may be an electric or hybrid vehicle. Other uses for the battery pack 600 may comprise a standalone battery pack for powering devices or installations or the like.

It will be appreciated that the advantages described above in respect of, e.g., energy density, conferred to the secondary cells according to aspects of the present disclosure, will also be conferred to a battery pack comprising said cells, and any vehicle comprise such a battery pack. Thus, these advantages are not discussed in detail again.

While the present disclosure is susceptible to various modifications and alternative forms, specific embodiments are shown and described above by way of example in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims.

1. A cylindrical secondary cell (100) comprising:
a cylindrical casing (102) extending along an axis (A) from a first end (102a) to a second end (102b), the first end (102a) being an open end of the casing (102);
an electrode roll (104) housed within the casing (102); and
a lid (106) closing the open end (102a) of the casing (102);
wherein:
the edge of the open end (102a) is bent inwards to provide a flange (102d) comprising an angled surface (102e) sloping towards the second end (102b) of the casing (102); and
the lid (106) is welded to the flange (102d) to thereby close the open end (102a) of the casing (102).

2. The cylindrical secondary cell (100) according to claim 1, wherein:
the periphery of the lid (106) has an angled surface (106a) configured to substantially match the angled surface (102e) of the flange (102d).

3. The cylindrical secondary cell (100) according to claim 1, wherein:
the periphery of the lid (106) is arranged between the flange (102d) and the electrode roll (104).

4. The cylindrical secondary cell according to claim 1, wherein:
the flange is arranged between the periphery of the lid and the electrode roll.

5. The cylindrical secondary cell according to claim 1, wherein:
the lid comprises a number of recessed contact portions arranged in direct electrical contact with the electrode roll, the area of the recessed contact portions being 50 to 80 percent of the total area of the lid.

6. The cylindrical secondary cell according to claim 5, wherein:
the extension of the recessed contact portions in an axial direction (A) of the cylindrical secondary cell (100) substantially equals the extension of the flange (102d) in the axial direction (A) of the cylindrical secondary cell (100).

7. The cylindrical secondary cell according to claim 1, wherein:
the flange is attached to a periphery of the lid along an attachment seam; and
the attachment seam is axially spaced from the electrode roll.

8. A method of manufacturing the secondary cylindrical cell according to claim 1, the method comprising:
bending the edge of the open end of the casing inwards to thereby form the flange;
arranging the periphery of the lid in abutment with the flange; and
welding the periphery of the lid and the flange together.

9. The method according to claim 8, wherein:
the lid comprises a first side for arranging in direct electrical contact with the electrode roll, and a second side opposite the first side;
the periphery of the lid (106) is arranged between the flange (102d) and the electrode roll (104); and
the method further comprises:
arranging the first side of the lid in direct electrical contact with the electrode roll; and
bending the edge of the open end of the casing inwards to thereby form the flange and bring the flange into contact with the periphery of the second side of the lid.

10. The method according to claim 8, wherein:
the lid comprises a first side for arranging in direct electrical contact with the electrode roll, and a second side opposite the first side;
the flange is arranged between the periphery of the lid and the electrode roll; and
the method further comprises:
bending the edge of the open end of the casing inwards to thereby form the flange; and
arranging the first side of the lid in direct electrical contact with the electrode roll such that the periphery of the first side of the lid contacts the flange.

11. The method according to claim 8, wherein:
welding the periphery of the lid and the flange together comprises:
sensing a contact force between the periphery of the lid and the flange; and
welding the periphery of the lid and the flange together in response to the contact force exceeding a threshold force.

12. The method according to claim 8, wherein:
the periphery of the lid (106) has an angled surface (106a) configured to substantially match the angled surface (102e) of the flange (102d); and
welding the periphery of the lid and the flange together comprises:
directing a welding means at the angled surface (102e) of the flange (102d) from an angle substantially orthogonal to the angled surface of the flange.

13. A battery pack comprising a plurality of cylindrical secondary cells, wherein at least one of the plurality of cylindrical secondary cells is the cylindrical secondary cell according to claim 1.

14. A vehicle comprising the battery pack according to claim 13.
